(19) United States
(12) Patent Application Publication
(10) Pub. No.: US 2006/0082650 A1
(43) Pub. Date: Apr. 20, 2006

(54) Helping hand

(76) Inventor: John Harvey Leask, Medicine Hat (CA)

Correspondence Address: John Leask, 821 - 9 Street SE, Medicine Hat, T1A 1P5, CA

(21) Appl. No.: 10/789,568

(22) Filed: Oct. 18, 2004

(51) Int. Cl. H04N 7/18; H04N 9/47

(52) U.S. Cl. 348/126

(57) ABSTRACT

This device is made to help those peopl that are viually impaired live a more normal life By being able to read and view pictures and what ever the would like to look at that the Normaly would be unable to do with out some sort of help.

This idea came about as a need for a better reading device with a good soze floating table to hold a phone book or news paper on it wit out falling off one side. There are other devices on the market but I have not fownd one that is similer in size. Or as easy to use and as portable. I am leagaly blind myself and need some thing to help me read a paper or instructions on how to operate something.

This device is very easy to use it has a CCTV camera suspended over a floating t5able that moves in all directions. The camera is connected to a house hold TV with a camcorder input on it where the image of what you have on the table is projected on the TV screen so a person with low vision can see or read it.

The discription of the HELPING HAND reading device,

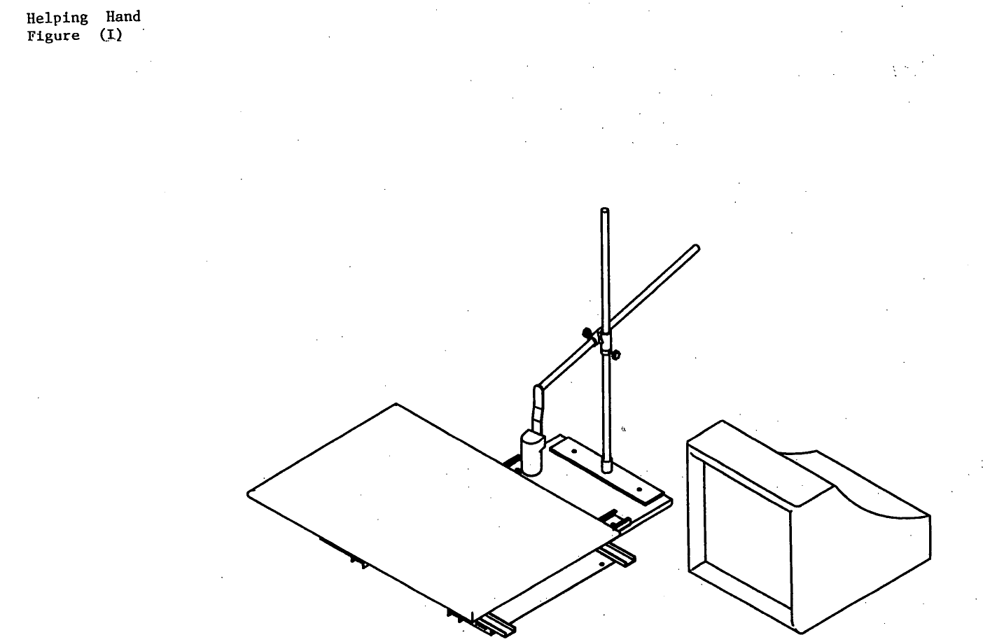

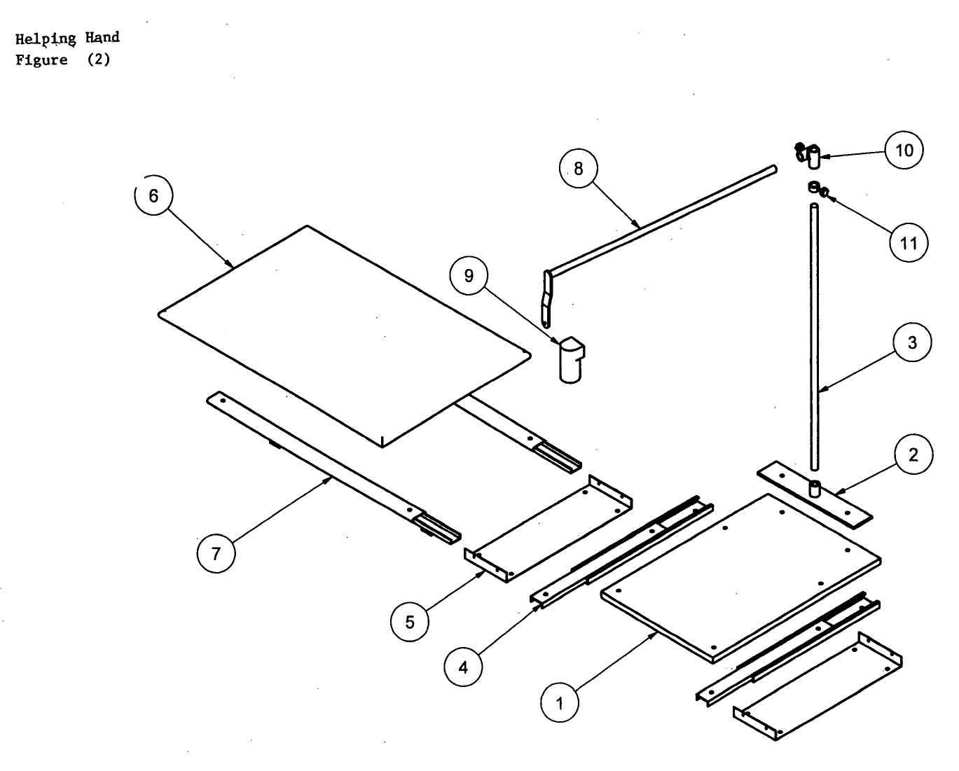

(FIG. 1) The Helping Hand atachet to a TV ready to use.

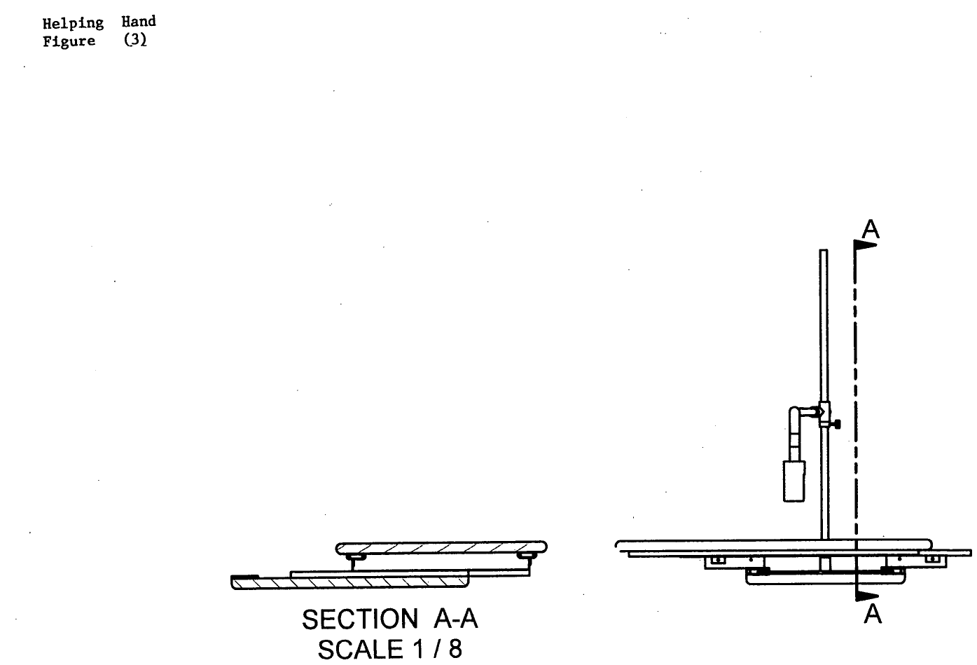

(FIG. 2) the floating table parts (1) the table base [16×22] (2) camera post base (3) camera holding post (4) 14″ full extensio slide that is atached to the table base (5) bracket that that ataches the 14″ slide to the 22″ two way slide (6) floating table top [size 16×24] (7) 22″ two way slide that fatens under the table top and atached to the bracket and the 14″ slide so the table will be able to move in all directions. (Items 3,9,10,&11 See FIG. 2A for detail changes to camera holding setup (8) camera that hooks to the tv

(FIG. 2A) camera holding assembly (1) main post (2) block from main post to camera holding arm (3) camera holdingt arm (4) crank to ajust camera hight for proper focus (5) thum screw to lock no. 3 to no. 2 (6) post base that is atached to table bace (7) thum scrw that locks post to post base.

(figue 3) fromt view of table

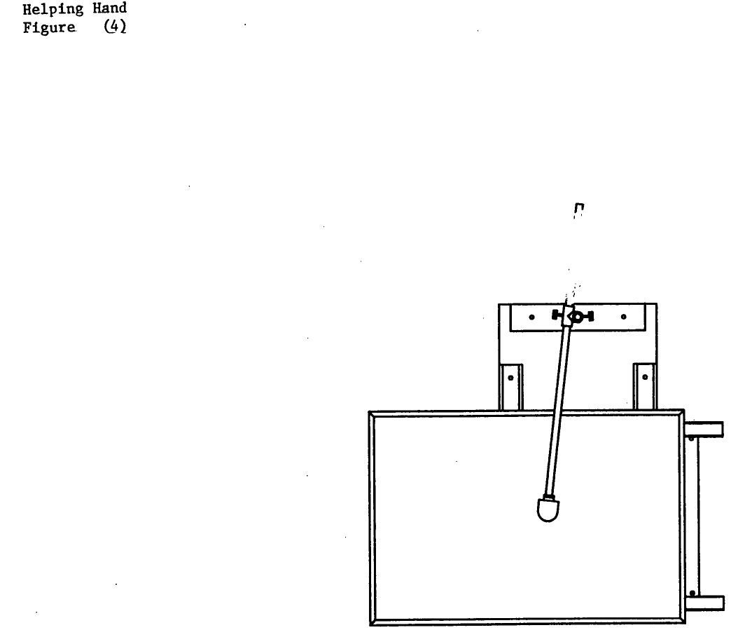

(FIG. 4) top view of table

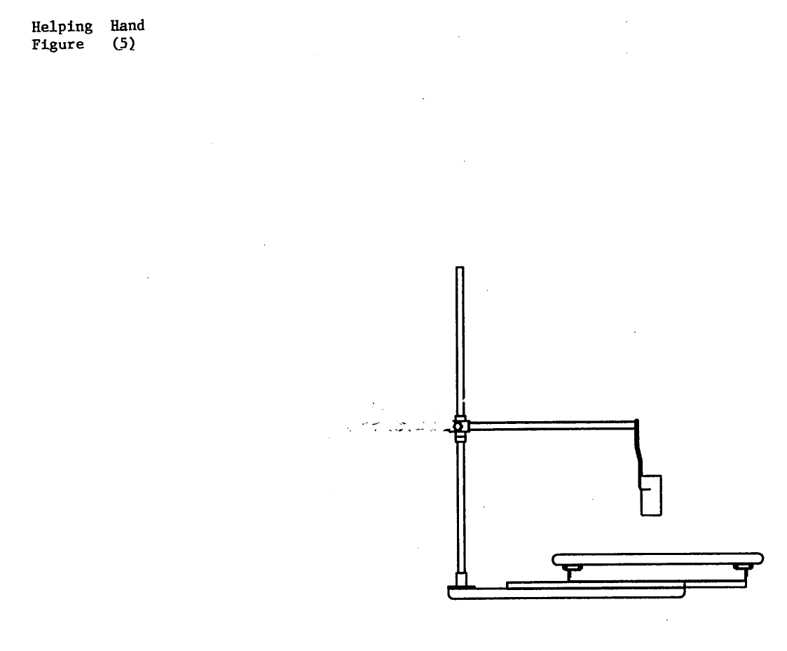

(FIG. 5) side view of assembly

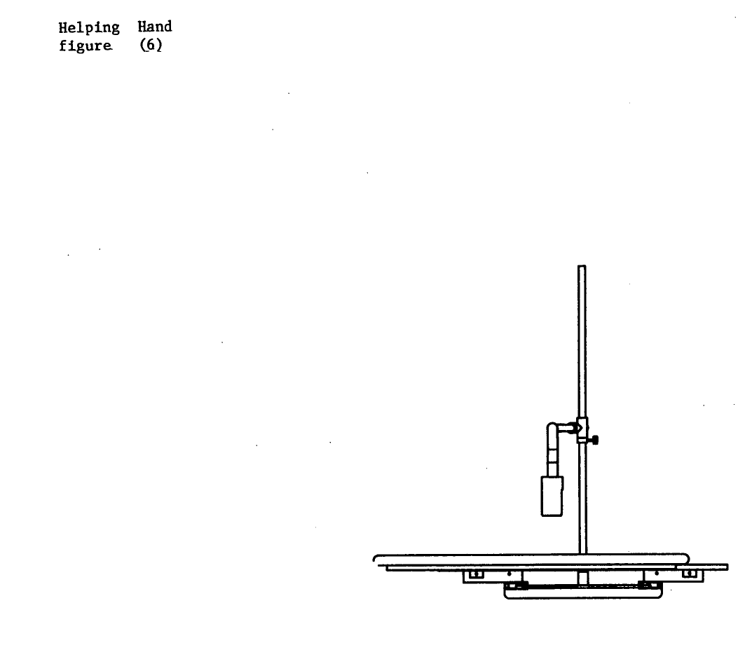

(FIG. 6) front view of assembly with the table moved to the left.

1. This reading device was designed by a visually impaired person so as to make life more Enjoyable for others in the same situationn. The table is large enough to hold a phone Book, news paper, or what ever you wish to look at or read.
